(19) United States
(12) Patent Application Publication
(10) Pub. No.: US 2024/0220819 A1
(43) Pub. Date: Jul. 4, 2024

(54) COMPILING METHOD, RUNNING METHOD, AND RELATED PRODUCT

(71) Applicant: Shanghai Cambricon Information Technology Co., Ltd, Shanghai (CN)

(72) Inventors: Xueting GUO, Shanghai (CN); Huiying LAN, Shanghai (CN)

(21) Appl. No.: 18/374,262

(22) Filed: Sep. 28, 2023

(30) Foreign Application Priority Data
Dec. 28, 2022 (CN) 202211700640.4

(51) Int. Cl. G06N 3/10

(52) U.S. Cl. CPC G06N 3/10

(57) ABSTRACT

A compiling method for a computing graph is implemented by a processing apparatus, and a running method for a computing graph is implemented by a computing apparatus. The processing apparatus and the computing apparatus are included in a combined processing apparatus. The combined processing apparatus further includes an interface apparatus. The computing apparatus interacts with the processing apparatus to jointly complete a computing operation specified by a user. The combined processing apparatus further includes a storage apparatus. The storage apparatus is respectively connected to the computing apparatus and the processing apparatus and is configured to store data of the computing apparatus and the processing apparatus. The compiling method and the running method for the computing graph may simplify user operations and improve optimization performance of the computing graph.

### PRIORITY

This application claims the benefit under 35 USC § 119 of Chinese Patent Application No. 202211700640.4, filed on Dec. 28, 2022, in the China Intellectual Property Office, the entire disclosure of which is incorporated herein by reference for all purposes.

### BACKGROUND

### 1. Technical Field

The present disclosure generally relates to the field of intelligent computing, and in particular to the field of neural network. More specifically, the present disclosure relates to a compiling method for a computing graph implemented by a processing apparatus, a running method for a computing graph implemented by a computing apparatus, and related products.

### BACKGROUND

Recently, dynamic neural network technology has been paid more and more attention by researchers because of its powerful ability to express complex network architectures with dynamic control flows and variable data sizes. As dynamic neural network becomes more and more important in natural language processing and semantic segmentation, frameworks widely used at present also begin to support dynamic neural network technology.

In an intelligent computing system, through programming frameworks, common operations in a neural network model algorithm are encapsulated into operators for programmers to call directly, such as convolution and pooling. TensorFlow and PyTorch are currently popular deep learning frameworks. In these programming frameworks, a computing graph is usually used to describe a computing process of machine learning algorithm, tensors are used to represent all data in the computing graph, and operators are used to represent various operations.

In the deep learning framework, an input with a variable data size is accepted as an input of a deep neural network model. However, this form of variable input often leads to poor performance in the neural network inference phase because it may generally be assumed that the more specific the given input range, the better the performance optimization.

Based on this, there is an urgent need for a compiling solution for a computing graph, which may provide performance optimization of the computing graph for the input with the variable data size.

### SUMMARY

In order to at least address one or a plurality of technical problems mentioned above, the present disclosure provides a compiling solution and running solution for a computing graph in many aspects.

A first aspect of the present disclosure provides a compiling method for a computing graph implemented by a processing apparatus, including: acquiring a computing graph of a neural network model, where input data of the computing graph is configured with one or a plurality of groups of variable input ranges; for each group of variable input range, compiling and optimizing the computing graph to generate a corresponding performance optimization graph; and storing each group of variable input range in association with a corresponding performance optimization graph to generate a runtime file to be assigned to a computing apparatus to perform a task corresponding to the computing graph.

A second aspect of the present disclosure provides a running method for a computing graph implemented by a computing apparatus, including: loading a runtime file of a computing graph, where the runtime file has a plurality of groups of variable input ranges and corresponding performance optimization graphs that are stored in association with the plurality of groups of variable input ranges, and the runtime file is generated according to the compiling method of the first aspect; according to an input value at runtime, selecting a performance optimization graph corresponding to a group of variable input range hit by the input value; and running the selected performance optimization graph.

A third aspect of the present disclosure provides a processing apparatus, configured to compile a computing graph, including: a processor, configured to perform a program instruction; and a memory, configured to store the program instruction, where when the program instruction is loaded and performed by the processor, the processor performs the compiling method for the computing graph of the first aspect.

A fourth aspect of the present disclosure provides a computing apparatus, configured to run a computing graph, including: a processor, configured to perform a program instruction; and a memory, configured to store the program instruction, where when the program instruction is loaded and performed by the processor, the processor performs the running method for the computing graph of the second aspect.

A fifth aspect of the present disclosure provides a computer-readable storage medium, on which a program instruction is stored, where when the program instruction is loaded and performed by a processor, the processor performs the compiling method for the computing graph of the first aspect or the running method for computing graph of the second aspect.

A sixth aspect of the present disclosure provides a computer program product, including a computer program or instruction, where when the computer program or instruction is performed by a processor, the compiling method for the computing graph of the first aspect or the running method for the computing graph of the second aspect is implemented.

A seventh aspect of the present disclosure provides a combined processing apparatus, including the processing apparatus of the third aspect and the computing apparatus of the fourth aspect.

An eighth aspect of the present disclosure provides a chip, including the combined processing apparatus of the seventh aspect. A ninth aspect of the present disclosure provides a board card, including the chip of the eighth aspect.

Through the compiling solution and running solution for the computing graph mentioned above, the present disclosure provides an optimization solution for compilation of a computing graph with a variable input, which may support a plurality of groups of variable input ranges and respectively provide performance optimization graphs based on the plurality of groups of variable input ranges. In this compiling solution, the setting of the variable input range is easy. The variable input range is required to be set only once and no other operation is required. Further, at runtime of the computing graph, an optimal graph in a plurality of groups of performance optimization graphs may be identified automatically to run, which optimizes redundant steps and further optimizes inference performance of the deep learning framework.

### BRIEF DESCRIPTION OF THE DRAWINGS

By reading the following detailed description with reference to drawings, the above and other objects, features and technical effects of exemplary implementations of the present disclosure will become easier to understand. In the drawings, several implementations of the present disclosure are shown in an exemplary but not restrictive manner, and the same or corresponding reference numerals indicate the same or corresponding parts.

FIG. 1 shows a structural diagram of a board card according to an embodiment of the present disclosure.

FIG. 2 shows a structural diagram of a combined processing apparatus according to an embodiment of the present disclosure.

FIG. 3 shows a schematic diagram of an internal structure of a single processor core of a single-core or multi-core computing apparatus according to an embodiment of the present disclosure.

FIG. 4 shows an exemplary flowchart of a compiling method for a computing graph implemented by a processing apparatus according to an embodiment of the present disclosure.

FIG. 5 shows an exemplary flowchart of a compiling method for a computing graph implemented by a processing apparatus according to another embodiment of the present disclosure.

FIG. 6 shows an exemplary shape derivation example of a computing graph in a traditional way.

FIG. 7 shows an exemplary flowchart for shape derivation of a node of a computing graph according to an embodiment of the present disclosure.

FIG. 8 shows an exemplary flowchart for shape derivation of a node of a computing graph according to another embodiment of the present disclosure.

FIG. 9 shows an exemplary flowchart of a running method for a computing graph implemented by a computing apparatus according to an embodiment of the present disclosure.

FIG. 10 shows a hard configuration diagram of a processing apparatus 1000 capable of implementing a compiling solution of an embodiment of the present disclosure.

### DETAILED DESCRIPTION

Technical solutions in embodiments of the present disclosure will be described clearly and completely hereinafter with reference to drawings in the embodiments of the present disclosure. Obviously, embodiments to be described are merely some rather than all embodiments of the present disclosure. All other embodiments obtained by those skilled in the art based on the embodiments of the present disclosure without creative efforts shall fall within the scope of protection of the present disclosure.

It should be understood that terms such as “first”, “second”, “third”, and “fourth” appear in the claims, specification, and drawings are used for distinguishing different objects rather than describing a specific order. It should be understood that terms “including” and “comprising” used in the specification and the claims indicate the presence of a feature, an entity, a step, an operation, an element, and/or a component, but do not exclude the existence or addition of one or more of other features, entities, steps, operations, elements, components, and/or collections thereof.

It should also be understood that terms used in the specification of the present disclosure are merely intended to describe a specific embodiment rather than to limit the present disclosure. As being used in the specification and the claims of the present disclosure, unless the context clearly indicates otherwise, singular forms such as “a”, “an” and “the” are intended to include plural forms. It should also be understood that a term “and/or” used in the specification and the claims refers to any and all possible combinations of one or more of relevant listed items and includes these combinations.

As being used in the specification and the claims of the present disclosure, a term “if” may be interpreted as “when”, or “once” or “in response to a determination” or “in response to a case where something is detected” depending on the context. Similarly, depending on the context, a clause “if it is determined that” or “if [a described condition or event] is detected” may be interpreted as “once it is determined that”, or “in response to a determination”, or “once [a described condition or event] is detected”, or “in response to a case where [a described condition or event] is detected”.

Specific implementations of the present disclosure will be described in detail in combination with drawings below.

### EXEMPLARY HARDWARE ENVIRONMENT

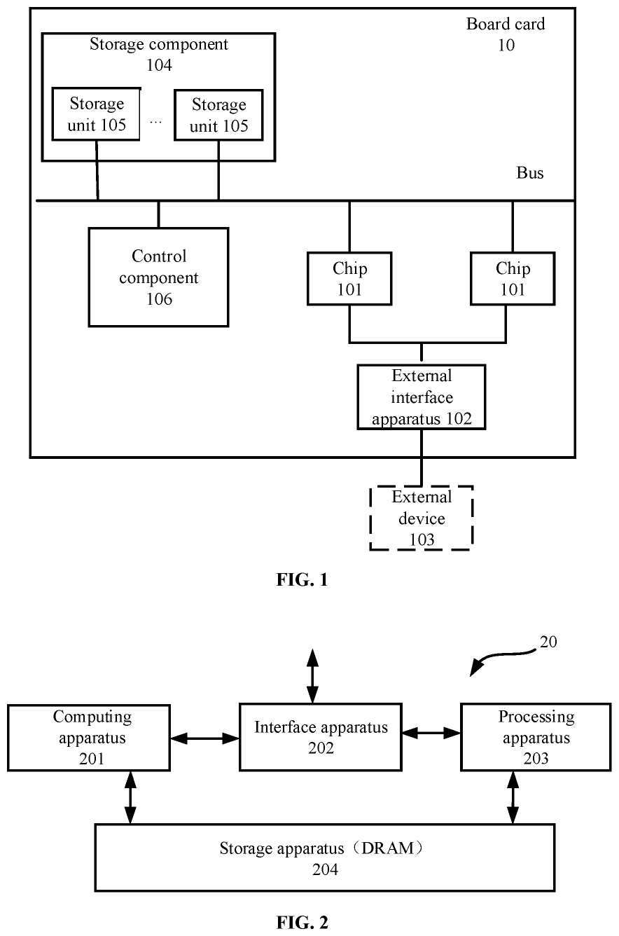

FIG. 1 is a schematic structural diagram of a board card 10 according to an embodiment of the present disclosure. As shown in FIG. 1, the board card 10 includes a chip 101, which is a system on chip (SoC), or called an on-chip system, and integrates one or a plurality of combined processing apparatuses. The combined processing apparatus is an artificial intelligence operation unit, which is configured to support various deep learning algorithms and various machine learning algorithms and meet requirements of intelligent processing in complex scenarios in computer vision, speech, natural language processing, data mining, and other fields. In particular, deep learning technology is widely used in the field of cloud intelligence. A notable feature of cloud intelligence applications is a large amount of input data, which has high requirements for storage capacity and computing power of a platform. The board card 10 of this embodiment is suitable for the cloud intelligent applications and has a huge off-chip storage, a huge on-chip storage, and great computing power.

The chip 101 is connected to an external device 103 through an external interface apparatus 102. The external device 103 may be, for example, a server, a computer, a camera, a monitor, a mouse, a keyboard, a network card, or a WIFI interface. To-be-processed data may be transferred from the external device 103 to the chip 101 through the external interface apparatus 102. A computing result of the chip 101 may be transferred back to the external device 103 through the external interface apparatus 102. According to different application scenarios, the external interface apparatus 102 may have different interface forms, such as a standard peripheral component interface express (PCIe) interface, and the like.

The board card 10 further includes a storage component 104 used for storing data. The storage component 104 includes one or a plurality of storage units 105. The storage component 104 is connected to and transfers data to a control component 106 and the chip 101 through a bus. The control component 106 in the board card 10 is configured to regulate and control a state of the chip 101. As such, in an application scenario, the control component 106 may include a micro controller unit (MCU).

FIG. 2 is a structural diagram of a combined processing apparatus in the chip 101 of this embodiment. As shown in FIG. 2, a combined processing apparatus 20 includes a computing apparatus 201, an interface apparatus 202, a processing apparatus 203, and a storage apparatus 204.

The computing apparatus 201 is configured to perform an operation specified by a user. The computing apparatus 201 is mainly implemented as a single-core intelligent processor or a multi-core intelligent processor and is configured to perform deep learning computing or machine learning computing. The computing apparatus 201 interacts with the processing apparatus 203 through the interface apparatus 202 to jointly complete the operation specified by the user.

The interface apparatus 202 is configured to transfer data and control instructions between the computing apparatus 201 and the processing apparatus 203. For example, the computing apparatus 201 may acquire input data from the processing apparatus 203 via the interface apparatus 202 and write the input data to an on-chip storage apparatus of the computing apparatus 201. Further, the computing apparatus 201 may acquire control instructions from the processing apparatus 203 via the interface apparatus 202 and write the control instructions to an on-chip control cache of the computing apparatus 201. Alternatively or optionally, the interface apparatus 202 may further read data in the storage apparatus of the computing apparatus 201 and then transfer the data to the processing apparatus 203.

The processing apparatus 203 serves as a general processing apparatus and performs basic controls that include but are not limited to moving data, starting and/or stopping the computing apparatus 201. According to different implementations, the processing apparatus 203 may be a central processing unit (CPU), a graphics processing unit (GPU), or one or more of other general and/or dedicated processors. These processors include but are not limited to a digital signal processor (DSP), an application specific integrated circuit (ASIC), a field-programmable gate array (FPGA), or other programmable logic components, discrete gate or transistor logic components, discrete hardware components, and the like. Moreover, a count of the processors may be determined according to actual requirements. As described above, with respect to the computing apparatus 201 of the present disclosure only, the computing apparatus 201 of the present disclosure may be viewed as having a single-core structure or an isomorphic multi-core structure. However, when considered together, the computing apparatus 201 and the processing apparatus 203 are viewed as forming a heterogeneous multi-core structure.

The storage apparatus 204 is configured to store to-be-processed data. The storage apparatus 204 may be a dynamic random access memory (DRAM), which is a double data rate (DDR) memory with a size of 16G or more than 16G generally. The storage apparatus 204 is configured to save data of the computing apparatus 201 and/or the processing apparatus 203.

When the computing apparatus 201 runs a neural network, it is generally first necessary to use the processing apparatus 203 to compile the neural network to obtain an executable file, where the executable file contains device information about which device in a heterogeneous computer system the executable file is required to be executed on. After the executable file is assembled and linked, an executable program of the neural network is obtained, and the executable program is stored in the storage apparatus 204.

The processing apparatus 203 may read the executable program from a position where the executable program is stored and obtain a plurality of tasks of the program according to the executable program. These tasks are distributed to the computing apparatus 201 for execution via the interface apparatus 202, and finally, an operation result is obtained.

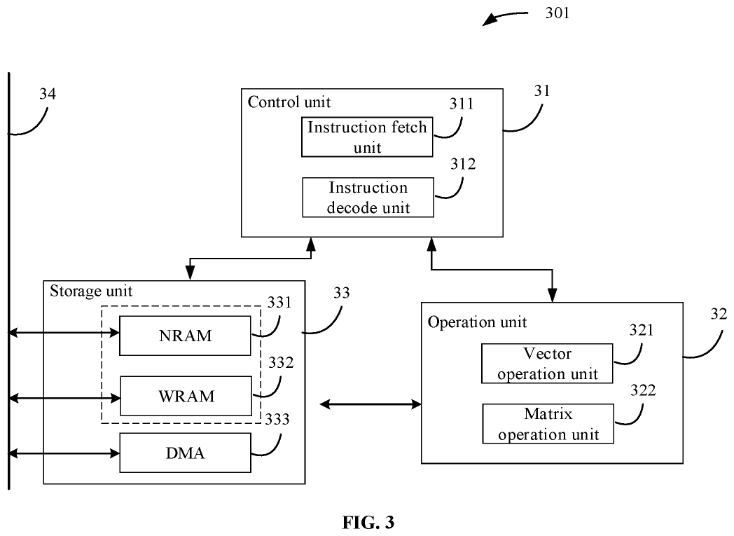

FIG. 3 is a schematic diagram of an internal structure of a single processing core when the computing apparatus 201 in FIG. 2 is a single-core apparatus or a multi-core apparatus. A computing apparatus 301 is configured to process input data in computer vision, speech, natural language, data mining, and the like. The computing apparatus 301 includes three units: a control unit 31 (also known as a controller), an operation unit 32 (also known as an operator), and a storage unit 33 (also known as a memory).

The control unit 31 is configured to coordinate and control work of the operation unit 32 and the storage unit 33 to complete a deep learning task. The control unit 31 includes an instruction fetch unit (IFU) 311 and an instruction decode unit (IDU) 312. The IFU 311 is configured to acquire an instruction from the processing apparatus 203. The IDU 312 is configured to decode the instruction acquired and send a decoding result as control information to the operation unit 32 and the storage unit 33.

The operation unit 32 includes a vector operation unit 321 and a matrix operation unit 322. The vector operation unit 321 is configured to perform a vector operation and supports complex operations such as vector multiplication, addition, and nonlinear conversion. The matrix operation unit 322 is responsible for core computing of deep learning algorithm, such as matrix multiplication and convolution.

The storage unit 33 is configured to store or move related data and includes a neuron storage unit (neuron random access memory (RAM), NRAM) 331, a weight storage unit (weight RAM, WRAM) 332, and a direct memory access (DMA) unit 333. The NRAM 331 is configured to store input neuron, output neuron, and an intermediate result after computing. The WRAM 332 is configured to store a convolution kernel of a deep learning network, which is a weight. The DMA 333 is connected to the DRAM 204 through a bus 34 and is responsible for data moving between the computing apparatus 301 and the DRAM 204. It should be noted that, here, the NRAM and the WRAM may be either two storage areas formed by dividing a same memory in logical storage space or two separate memories, which is not limited herein.

### Exemplary Computing Graph Compiling Solution

As mentioned before, with the continuous development of natural language processing and semantic segmentation, dynamic neural network is applied in more and more deep neural networks. Compared with a static neural network, a dynamic neural network has an unfixed computing graph, which includes a variable size, a variable structure or control flow. Dynamic neural network technology supports a variable network structure through dynamic declarations at runtime, thereby enabling an application requiring a complex neural network structure.

Specifically, the dynamic neural network is usually applied in following scenarios: 1) sequence language model. Inputs of these models are sequences that are usually of variable lengths. 2) Tree structure recurrent neural network (RNN). For a language model with sentiment analysis, inputs are tree structures, and these tree structures change for different sentences. 3) Neural architecture search (NAS). The NAS aims to find an optimal model for a specific task by repeatedly testing performance of different network architectures. During the task, the network architectures continue to evolve.

In some cases, the dynamic neural network may be simplified as the static neural network. For example, for a sequence language model with a variable sentence length, by adding redundant padding, all sentences may be aligned to the longest sentence. However, this will cause a lot of redundant and unnecessary computing.

The embodiment of the present disclosure primarily performs compilation and optimization at runtime for scenarios where input data has variable sizes. In a deep learning framework, a dominant performance optimization method is to set a dynamic input range by a user. The first known performance optimization solution is to provide a user with a variable input range through a configuration file. An example of a configuration file for input data “input” is as below:

```
″input_desc″: [
  {
    ″format″: ″ND″,
    ″shape″: [−1,16],
    ″shape_range″: [[0, 32]],
    ″type″: ″int64″
  },
```

the “shape” field in the configuration file is a one-dimensional array. The length of the array represents a dimension count of the input data “input”, and the value of the array represents a size of a corresponding dimension. In the above solution, “−1” in the “shape” field represents that this dimension is variable. The “shape_range” field in the configuration file is a two-dimensional array, which is used to represent a variation range of each variable dimension indicated by the “shape” field. For example, the variation range is represented by minimum and maximum values. In the above example, this “input” includes two dimensions, where a first dimension (such as a batch (N) dimension) is variable, and the variation range is 0˜32; and a second dimension (such as a channel (C) dimension) is fixed, and the size is 16. It may be understood that, if the “shape” indicates that the “input” has a plurality of dimensions variable, the “shape_range” is constantly expanded.

The representation of the first solution is cumbersome, not flexible enough, and does not support a plurality of groups of variation ranges of a same dimension. For example, the input variation range of N dimension includes 0˜32 and 64˜128, so this representation may not support the variation range and is easy to cause problems to users.

The second known performance optimization solution provides another way for users to set variable input ranges. An example of the configuration file is as follows:

IOptimizationProfile* profile = builder.createOptimizationProfile( );
profile->setDimensions(″foo″, OptProfileSelector::kMIN, Dims3(3,100,
200);
profile->setDimensions(″foo″, OptProfileSelector::kOPT, Dims3(3,150,
250);
profile->setDimensions(″foo″, OptProfileSelector::kMAX, Dims3(3,200,
300);
config->addOptimizationProfile(profile).

In this example, foo is a three-dimensional input, minimum values of three dimensions are set through “kMIN”, optimum values of the three dimensions are set through “kOPT”, and maximum values of the three dimensions are set through “kMAX”, thus setting a group of dynamic range for foo. It may be seen from the above example that a first dimension of foo is invariable and fixed to 3; a second dimension is variable and ranges from 100 to 200, preferably 150; and a third dimension is also variable and ranges from 200 to 300, preferably 250. When there are a plurality of groups of dynamic ranges, a plurality of profiles are required to be set and added.

The representation of the second solution supports the representation of the plurality of groups of ranges. Each group of range corresponds to one IOptimizationProfile. Each profile must be set with a corresponding min (minimum value), opt (optimum value) and max (maximum value). Further, the second solution requires the user to manually select which profile to use at runtime, which is equivalent to essentially still supporting only one group of range and is not flexible enough in use.

In short, the two known performance optimization solutions are not flexible enough for the setting of variable input range, and the operation is cumbersome. Although the second solution supports the plurality of groups of ranges, the second solution requires additional setup at runtime in addition to setting up a plurality of IOptimizationProfiles to support the plurality of groups of ranges, which is not conducive to further performance optimization.

In view of this, the embodiment of the present disclosure provides a compiling solution for a computing graph, which may support a plurality of groups of variable input ranges. The setting of variable input range is flexible, and the variable range is required to be set only once, and no other operations are required later. The compiling solution supports automatic identification of an optimal group in the plurality of groups of variable ranges and runs the group at runtime.

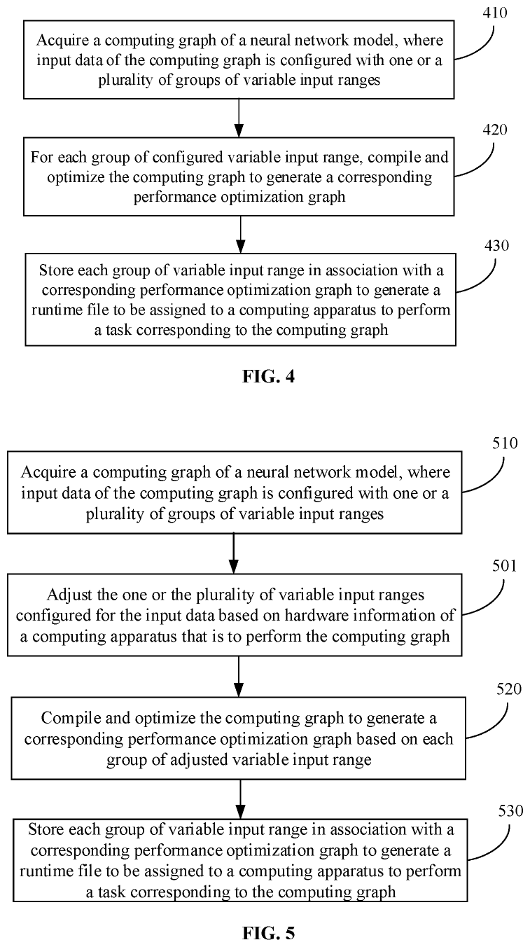

FIG. 4 shows an exemplary flowchart of a compiling method for a computing graph implemented by a processing apparatus according to an embodiment of the present disclosure. The processing apparatus, for example, may be the processing apparatus 203 of FIG. 2.

As shown in the figure, in a step 410, a computing graph of a neural network model is acquired, where input data of the computing graph is configured with one or a plurality of groups of variable input ranges.

The present disclosure provides a variable input range configuration method, which may flexibly set one or a plurality of groups of variable input ranges to simplify user operations.

In some embodiments, a variable input range is set for each input through a variable configuration item dim_range. Specifically, the variable configuration item dim_range sets two mandatory fields for each input: min and max. The min represents a minimum value of the variable input range, and the max represents a maximum value of the variable input range. The min and max fields include the setting of a corresponding group count, thus allowing one-to-one vertical mapping to form a group of completed input range setting.

Optionally, an optional field opt may also be set for each input additionally, where the optional field opt represents an optimum value of the variable input range. When the opt is set, the group count set in the opt also corresponds to the group counts set in the min and max fields. The following example 1 shows an example of setting the variable input range through the variable configuration item dim_range.

### Example 1

```
″dim_range″: {
    ″0″: {
      ″min″: {[1,16], [4,16], [ ]},
      ″opt″: {[4,16], [2,16], [8,16]},
      ″max″: {[8,16], [ ], [32,16]},
}
  }
```

A field “0” represents a 0-th input. In the min, max and opt fields, “[ ]” is used to split each group of setting. In the “[ ]”, there is a one-dimensional array, where a length of the array represents a dimension count of input data “0”, and a value of the array represents a corresponding setting value of a corresponding dimension.

In the above example, the input “0” has two dimensions and are set with three groups of variable input ranges, and in these three groups of variable input ranges, first dimensions are all variable, and second dimensions are all fixed to 16. Specifically, in a first group of variable input range, the first dimension is 1˜8, the second dimension is fixed to 16, and the optimum value of the first dimension is 4; in a second group of variable input range, the first dimension is 4˜8, the second dimension is fixed to 16, and the optimum value of the first dimension is 2; in a third group of variable input range, the first dimension is 1˜32, the second dimension is fixed to 16, and the optimum value of the first dimension is 8.

Further, the opt field may be set according to following rules, so that the user may flexibly choose the right way to set the opt field.

Rule 1: the opt field is optional and may not be set. If the opt field is set, 1<=min<=opt<=max is required.

Rule 2: a plurality of groups of preferred values may be set in the opt field, and the plurality of groups of preferred values are set through a two-dimensional array. When there are the plurality of groups of preferred values, non-first groups may be empty, and a group count of the opt for each input must be equal. If the input is static or scalar, the opt may not be set or may all be empty.

Rule 3: for the group count set in the opt, the static or scalar input may be set to 0 or n groups, where n≥1, and a variable input may only be set to n groups. Group counts set for all inputs must be the same. If the group count is empty, “[ ]” is used to occupy the bit; otherwise, an error is reported.

In each field, scenarios that allows the group count to be empty are as follows.

Rule 4: when a plurality of groups are set, a first group must be set, and if following groups are empty, a value of the first group is used.

Rule 5: if the input is the static input, the opt may not be set, and if the opt is set, min=opt=max is required.

Rule 6: if the input is the scalar input, the opt may not be set, and if the opt is set, min=opt=max=[ ] (empty) is required.

Here are a few more configuration examples to make it easier to understand the above setting rules.

### Example 2

```
″dim_range″: {
  ″0″: {
    ″min″: [1, 4],
    ″max″: [24, 256]
  },
  ″1″: {
    ″min″: [1],
    ″max″: [24]
  }
}
```

In the above example 2, “0” is a two-dimensional input, and “1” is a one-dimensional input. For both “0” and “1” inputs, only one group of variable input range is set, where a first dimension of “0” ranges from 1 to 24, a second dimension of “0” ranges from 4 to 256, and a first dimension of “1” ranges from 1 to 24. The opt field is not configured in the example 2.

### Example 3

```
″dim_range″: {
  ″0″: {
    ″min″: [1, 4],
    ″opt″: [[12, 128], [3, 7]],
    ″max″: [24, 256]
  },
  ″1″: {
    ″min″: [1],
    ″opt″: [[12], [ ]],
    ″max″: [24]
  },
  ″2″: {
    ″min″: [24],
    ″max″: [24]
    },
  ″3″: {
    ″min″: [ ],
      ″opt″: [[ ], [ ]],
    ″max″: [ ]
  }
}
```

In the above example 3, there are four inputs including “0”, “1”, “2” and “3”, where “0” is a variable two-dimensional input, “1” is a variable one-dimensional input, “2” is an invariable one-dimensional input, which is also a static input, and “3” is a scalar input. In the above example 3, only one group of variable range is set, and this group of variable range includes two groups of preferred values. It may be compared with the example 1 where three groups of variable ranges are set and each group of variable range includes one group of preferred values.

In the example 3, the opt of “0” is set with two groups, whose values are both between min and max (Rule 1, Rule 2). The opt of “1” is also set with two groups. A second group of the opt of “1” is empty, which represents that the value of the first group is used. The group count set in the opt of “1” must be the same as that of “0”. If the group count is empty, “[ ]” is used to occupy the bit (Rule 2, Rule 3 and Rule 4). “2” is the static input, and the opt may not be set (Rule 3, Rule 5). “3” is the scalar input. If the opt is set, min=opt=max=[ ] (Rule 3, Rule 6).

According to the above rules, one or a plurality of groups of variable input ranges may be flexibly configured for variable input data, and each group of variable input range may be configured with one or a plurality of groups of preferred values, thus simplifying user settings and flexibly adapting to various scenarios.

Continuing with FIG. 4, next, in a step 420, for each group of configured variable input range, the computing graph is compiled and optimized to generate a corresponding performance optimization graph.

Traditional optimization for the computing graph is carried out for an invariable input, and only shape information of the input is definite, the computing graph may be optimized correspondingly. In the embodiment of the present disclosure, for each group of variable input range, according to the input range, an output shape range of a node that may be computed in the computing graph is derived, thus performing corresponding optimization processing to obtain the performance optimization graph. When the variable input data is configured with the preferred value, each group of preferred value is treated as a separate group of variable input range to compile and optimize the computing graph and generate the corresponding performance optimization graph. It may be understood that there are only fixed point values in the variable input range composed of the preferred value. The following will detail the compilation and optimization of the computing graph when there are variable input ranges in combination with drawings.

Finally, in a step 430, each group of variable input range is stored in association with a corresponding performance optimization graph to generate a runtime file to be assigned to a computing apparatus to perform a task corresponding to the computing graph. For example, each group of variable input range and a corresponding high-performance graph may be saved in a serialized manner. Specifically, according to a sequential order of a first group of variable input range, a corresponding high-performance graph, a second group of variable input range and a corresponding high-performance graph, these variable input ranges and their corresponding high-performance graphs are saved in the same file together.

Therefore, the embodiment of the present disclosure provides a compiling method for a computing graph, where the configuration of a plurality of groups of variable input ranges for variable inputs of the computing graph is supported, and the setting of the variable input ranges is flexible and may be adapted to various scenarios. The configuration of the above variable input ranges may be performed through either a program interface or a configuration file, which is not limited in the embodiment of the present disclosure.

FIG. 5 shows an exemplary flowchart of a compiling method for a computing graph implemented by a processing apparatus according to another embodiment of the present disclosure.

As shown in the figure, steps 510, 520 and 530 in FIG. 5 correspond to the steps 410, 420 and 430 in FIG. 4. Descriptions of the steps 510, 520 and 530 are not repeated herein. The difference between FIG. 5 and FIG. 4 is that, before compiling and optimizing the computing graph, a step 501 is added to adjust the one or the plurality of variable input ranges configured for the input data based on hardware information of a computing apparatus that is to perform the computing graph.

A computing apparatus with different hardware configurations may have different optimization characteristics for different variable input ranges. Therefore, the one or the plurality of variable input ranges configured for the input data may be adjusted based on the hardware information of the computing apparatus that is to perform the computing graph to adapt to the optimization characteristics of the computing apparatus.

In some embodiments, adjusting the one or the plurality of groups of variable input ranges may include: based on hardware optimization characteristics of the computing apparatus, splitting the one or the plurality of groups of variable input ranges into a plurality of groups of variable input ranges suitable for the hardware optimization characteristics. For example, in an example, an operation apparatus containing some kind of AI chip has four processing cores, which have better processing performance when there are more than four batches (N dimension) than that in a case where there are less than four batches. The input data of the acquired computing graph is initially configured with one group of variable input range [1,48] in the N dimension. Then, in the embodiment of the present disclosure, this group of variable input range [1,48] may be split into two groups of variable input ranges: [1,4] and (4,48]. Thus, corresponding performance optimization may be performed according to characteristics of the AI chip.

Next, in a step 520, based on each group of adjusted variable input range, the computing graph is compiled and optimized to generate a corresponding performance optimization graph. For example, continuing with the above example, for [1,4], a corresponding performance optimization graph may be generated, and at the same time, for (4,48], a corresponding performance optimization graph may also be generated. Following steps are the same as those of FIG. 4 and will not be repeated.

Therefore, in addition to supporting the configuration of the plurality of groups of variable input ranges for the variable inputs of the computing graph, the compiling method for the computing graph of the above embodiment may further automatically adjust the variable input ranges according to the hardware information of the computing apparatus that is to perform the computing graph to adapt to the hardware optimization characteristics of the computing apparatus.

As mentioned before, the traditional optimization for the computing graph is carried out for the invariable input, and only the shape information of the input is definite, the computing graph may be optimized correspondingly.

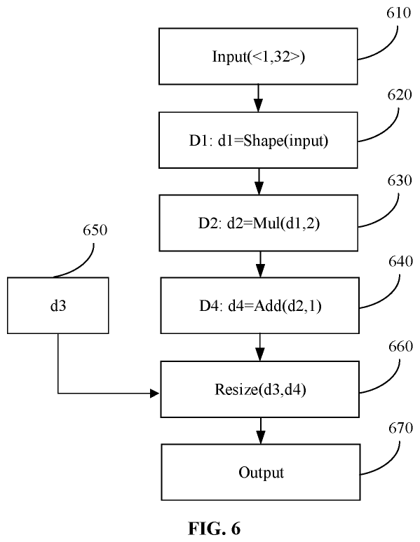

FIG. 6 shows an exemplary shape derivation example of a computing graph in a traditional way.

As shown in the figure, input data 610 of this computing graph is a two-dimensional input, whose shape is a fixed <1,32>, which means that a first dimension is 1, and a second dimension is 32. Next, a node D1 extracts a shape d1 (620) of an input; a node D2 multiplies (630) the extracted shape (d1) in the node D1 with a scalar 2; a node D4 adds (640) a product (d1) in the node D2 with 1; a node Resize resets (660) sizes of d3 (650) and d4; and finally, a final result is output (670).

In the traditional way, in the compilation phase of inference, when static analysis of the computing graph is performed, only when the input d4 of the node Resize has definite information about an output value, a definite shape of the output of the Resize is derived, and the subsequent computing graph may be further optimized.

In FIG. 6, the shape of the input is <1,32>, by taking the shape (d1) of the input, <2,64> (d2) is obtained by performing a multiplication operation on the two shapes, and then <3,65> (d4) is obtained by performing an addition operation. Therefore, in performing the static analysis, operations of D1, D2 and D4 may be merged into a constant (const) node, and the node is used as the input of the node Resize, thereby obtaining the shape of the output of the Resize.

However, when the input of the computing graph has a variable shape, d4 may not acquire a definite value, and the Resize is also unable to obtain definite shape information. As a result, the subsequent computing graph may not capture correct shape information, so that the computing graph may not be further optimized.

In short, when, in a variable computing graph, a computing node (such as the Resize node in the above figure) of the shape may be derived only when a dependent true value is encountered, the traditional way may not derive the shape range of the output of this computing node, so that shape ranges of all computing nodes in the whole computing graph may not be determined, which is not conducive to further performance optimization.

The embodiment of the present disclosure provides a solution that may be used to optimize a variable computing graph. When the shape range of the variable input is definite, according to the input range, the shape range of the output of the computing node may be derived.

For example, it is assumed that the computing graph of FIG. 6 is still taken as an example, where the input data “input” of the computing graph is a variable input <?,32>, which means that the first dimension is variable. In the embodiment of the present disclosure, if the range of the input is definite, according to the range of the input, an output range of each layer may be determined, and a mapping relationship between the output range and a node of a corresponding layer is saved, so that the output of the Resize is derived and the shape of the node of the subsequent computing graph is derived.

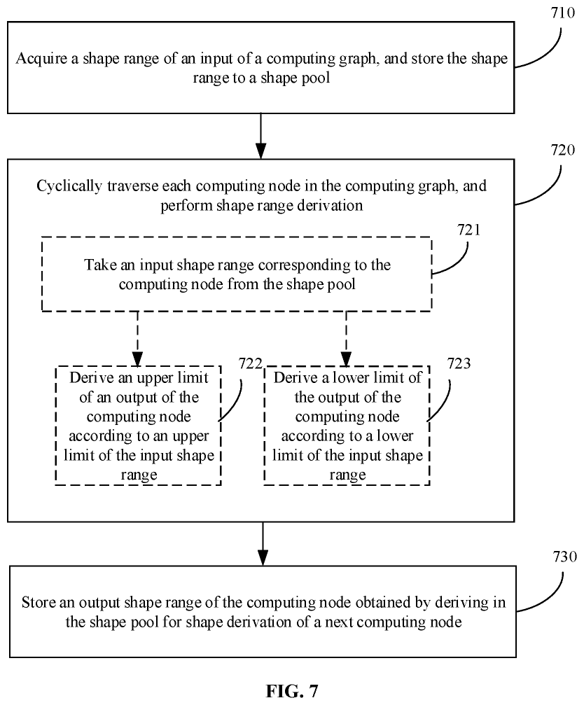

FIG. 7 shows an exemplary flowchart for shape derivation of a node of a computing graph according to an embodiment of the present disclosure. In this embodiment, shape range derivation of each node is performed. A shape pool may be created internally to save a shape range of each computing node. FIG. 7 only shows shape range derivation of one group of variable dynamic range. When there are a plurality of groups of variable dynamic ranges, method steps in FIG. 7 may be similarly repeated.

As shown in the figure, in a step 710, a shape range of an input of a computing graph is acquired, and the shape range is stored to a shape pool. Specifically, if the computing graph has a variable input, and there is a variable input range, this variable input range may be stored to the shape pool.

Next, in a step 720, each computing node in the computing graph is traversed cyclically, and shape range derivation is performed. Here, “shape range derivation” means that, when the input shape range of the computing node is definite, for example, when there is a specific minimum shape and a specific maximum shape, according to different shape derivation rules of the computing node, an output shape range of this computing node is derived.

Specifically, the shape range derivation may include: a step 721, where an input shape range corresponding to this computing node is taken out from the shape pool; a step 722, where a maximum shape of an output of the computing node is derived according to a maximum shape (upper limit) of the input shape range; and a step 723, where a minimum shape of the output of the computing node is derived according to a minimum shape (lower limit) of the input shape range. For example, assuming that input shape ranges of an add node are [1,16][32,16], which represent that a variable range of a first dimension is 1˜32 and a second dimension is fixed to 16, since the add node does not change the input shape, output shape ranges of the add node are also [1,16][32,16].

Finally, in a step 730, the maximum shape and minimum shape of the output of the computing node derived above are taken as the upper and lower limits of the output shape of the computing node, which constitute the shape range of the output of the computing node, and the shape range is stored in the shape pool for shape derivation of a next computing node. And so on, the dynamic range of the whole input variable computing graph may be derived for the optimization of the computing graph.

It may be known from the above that the embodiment of the present disclosure provides a solution for shape derivation of a computing graph with a variable input range, which overcomes the defect that the traditional technique may not optimize the variable computing graph.

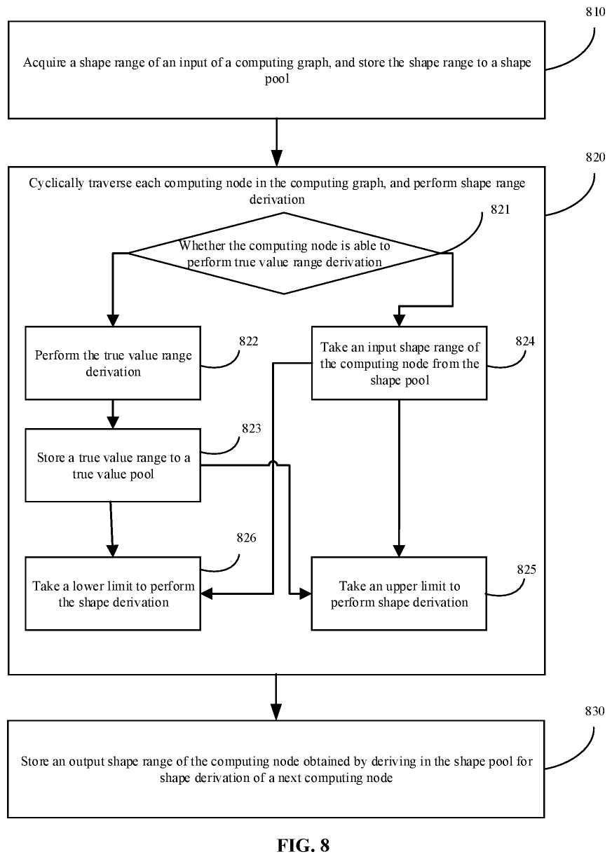

FIG. 8 shows an exemplary flowchart for shape derivation of a node of a computing graph according to another embodiment of the present disclosure. Steps 810 and 830 in FIG. 8 correspond to the steps 710 and 730 in FIG. 7. Related descriptions are not repeated herein. The difference between FIG. 8 and FIG. 7 is that, when each computing node is traversed (step 820), it is further judged that more useful information may be extracted to facilitate shape range derivation.

As shown in the figure, in a step 821, whether a currently processed computing node is able to perform truth value range derivation is judged. Here, “truth value range derivation” means that a range of a true value of an output of this computing node may be obtained according to input information of the computing node. Through the truth value range derivation, according to the known information, more information about a shape true value may be acquired as much as possible, which is conducive to shape range derivation of a subsequent computing node.

If the truth value range derivation is possible, this process proceeds to a step 822 to perform the truth value range derivation. For example, according to shape transformation characteristics of different nodes, a definite true value range of the output of the computing node is derived. Taking a structure of the computing graph of FIG. 6 as an example, in this example, the input data “input” of the computing graph is the variable input <−1,16>, and the node D1 is to extract the shape information of the input, so the shape of the output is <2>, which means that the shape is definite and represents a piece of two-dimensional data. When the dynamic range of the input data “input” is [1,16][32,16], the shape true value range of the output is [1,16][32,16], which means that, in addition to information that the shape is two-dimensional, there is also information that the true value of the first dimension is 1˜32, and the true value of the second dimension is 16.

Next, in a step 823, the true value range obtained from the true value range derivation is stored to a true value pool. Information of the true value pool may be used to shape range derivation of other related computing nodes.

Going back to the step 821, if the currently processed computing node is unable to perform the true value range derivation, the shape range derivation described above in combination with FIG. 7 is continued. Specifically, in a step 824, an input shape range corresponding to this computing node is taken out from the shape pool; in a step 825, a maximum shape of the output of the computing node is derived according to a maximum shape (upper limit) in the input shape range; and in a step 826, a minimum shape of the output of the computing node is derived according to a minimum shape (lower limit) in the input shape range. The difference from FIG. 7 is that the shape derivation of the steps 826 and 827 may also refer to data in the true value pool. If there is a range of a corresponding true value of an input of this computing node in the true value pool, the range of the true value may be used as upper and lower limits of a variable input range, and based on this, shape derivation is performed. Generally speaking, the true value range of the true value pool is less than the shape range derived based on the variable range of the input. Therefore, the true value pool provides more information for the shape derivation, which may further limit the size of the variable range and then be conducive to the optimization of the computing graph.

The compiling method for the computing graph provided by the embodiment of the present disclosure is described in the above in combination with drawings. The embodiment of the present disclosure also provides a runtime method for a computing graph.

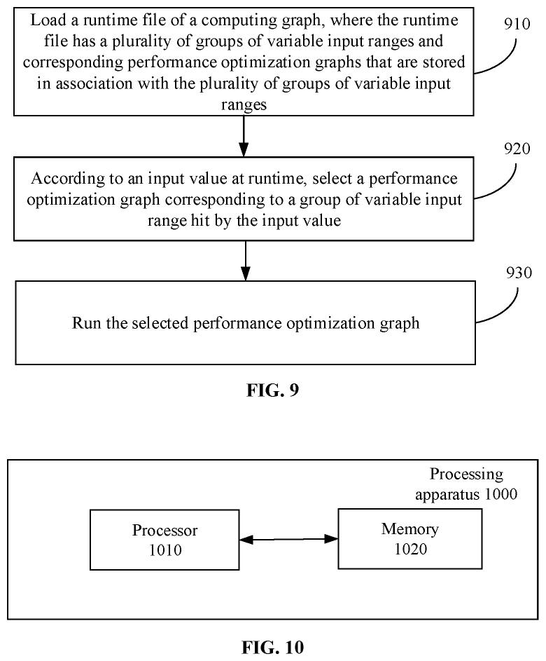

FIG. 9 shows an exemplary flowchart of a running method for a computing graph implemented by a computing apparatus according to an embodiment of the present disclosure. The computing apparatus, for example, may be the computing apparatus 201 of FIG. 2.

As shown in the figure, in a step 910, the computing apparatus loads a runtime file of the computing graph, where the runtime file has a plurality of groups of variable input ranges and corresponding performance optimization graphs that are stored in association with the plurality of groups of variable input ranges. It may be understood that this runtime file is generated according to the compiling method described above.

Next, in a step 920, according to an input value at runtime, a performance optimization graph corresponding to a group of variable input range hit by the input value is selected. At runtime, input data is definite, so a performance optimization graph suitable for the input data may be matched according to the definite input value; in other words, the performance optimization graph is a performance optimization graph corresponding to the variable input range into which the input value falls. It may be understood that, when the runtime file contains a preferred value and a corresponding performance optimization graph, if the input value just matches the preferred value, the performance optimization graph corresponding to the preferred value is selected, thereby achieving optimal optimization performance.

Finally, in a step 930, the selected performance optimization graph is run.

Therefore, the embodiment of the present disclosure provides a runtime solution for a computing graph, which, for a computing graph with a variable input, may automatically select an optimal performance optimization graph at runtime, without the need for the user to perform additional manual settings at runtime, which optimizes redundancy processes and simplifies user operations.

The present disclosure also provides a processing apparatus, which may compile a computing graph according to the method described above.

FIG. 10 shows a hard configuration diagram of a processing apparatus 1000 capable of implementing a compiling solution of an embodiment of the present disclosure. As shown in the figure, the processing apparatus 1000 may include a processor 1010 and a memory 1020. In the processing apparatus 1000 of FIG. 10, only components relevant to this embodiment are shown. Therefore, it is obvious to those skilled in the art that the processing apparatus 1000 may further include common components that differ from those shown in FIG. 10, such as a display.

The processing apparatus 1000 may correspond to a computing device with various processing functions, such as functions for programming and compiling source codes. For example, the processing apparatus 1000 may be implemented as various types of devices, such as a personal computer (PC), a server device, a mobile device, and the like.

The processor 1010 is configured to perform a program instruction to control all functions of the processing apparatus 1000. For example, the processor 1010 performs a program stored in the memory 1020 of the processing apparatus 1000 to control all functions of the processing apparatus 1000. The processor 1010 may be implemented by a central processing unit (CPU), a graphics processing unit (GPU), an application processor (AP), an intelligence processing unit (IPU), and the like, provided in the processing apparatus 1000. However, the present disclosure does not limit this.

The memory 1020 is configured to store hardware of various data processed in the processing apparatus 1000. For example, the memory 1020 stores data processed and to be processed in the processing apparatus 1000. The memory 1020 may store data processed and to be processed in the processor 1010, such as source codes before compilation, assembly instructions after compilation, and the like. Additionally, the memory 1020 may store program instructions such as application and driver programs to be driven by the processing apparatus 1000. For example, the memory 1020 may store various programs related to the compiling method for the computing graph to be performed by the processor 1010. The memory 1020 may be a dynamic random access memory (DRAM), which is not limited in the present disclosure. The memory 1020 may include at least one of a volatile memory or a nonvolatile memory. The nonvolatile memory may include a read only memory (ROM), a programmable ROM (PROM), an electrically PROM (EPROM), an electrically erasable PROM (EEPROM), a flash memory, a phase-change RAM (PRAM), a magnetic RAM (MRAM), a resistive RAM (RRAM), a ferroelectric RAM (FRAM), and the like. The volatile memory may include a dynamic RAM (DRAM), a static RAM (SRAM), a synchronous DRAM (SDRAM), the PRAM, the MRAM, the RRAM, the FRAM, and the like. In this embodiment, the memory 1020 may include at least one of a hard disk drive (HDD), a solid state drive (SSD), a compact flash (CF), a secure digital (SD) card, a Micro-SD card, a Mini-SD card, a limit digital (xD) card, caches or a memory stick.

In short, specific functions implemented by the memory 1020 and the processor 1010 in the processing apparatus 1000 provided by the embodiment of this specification may be interpreted in contrast to the foregoing embodiments in this specification and may achieve the technical effects of the above-mentioned embodiments, which will not be repeated herein.

The present disclosure also provides a computing apparatus, which may run a computing graph according to the method described above. The approximate structure of the computing apparatus may be similar to that of the processing apparatus described above in conjunction with FIG. 10; the detailed structure of the computing apparatus may be described above in conjunction with FIG. 3, which will not be repeated herein.

The embodiment of the present disclosure also provides a computer-readable storage medium, on which a program instruction is stored, where when the program instruction is loaded and performed by a processor, the processor performs the compiling method or running method for the computing graph described in the embodiment of the present disclosure. The embodiment of the present disclosure also provides a computer program product, including a computer program or instruction, where when the computer program or instruction is performed by a processor, the compiling method or running method for the computing graph described in the embodiment of the present disclosure is implemented.

The embodiment of the present disclosure also provides a combined processing apparatus, including the above processing apparatus configured to compile the computing graph and the above computing apparatus configured to run the computing graph. The embodiment of the present disclosure also provides a chip, including the above combined processing apparatus. Further, the present disclosure also provides a board card, including the above chip.

According to different application scenarios, an electronic device or apparatus of the present disclosure may include a server, a cloud server, a server cluster, a data processing apparatus, a robot, a computer, a printer, a scanner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car; the household appliance includes a television, an air conditioner, a microwave oven, a refrigerator, an electric rice cooker, a humidifier, a washing machine, an electric lamp, a gas cooker, and a range hood; and the medical device includes a nuclear magnetic resonance spectrometer, a B-ultrasonic scanner, and/or an electrocardiograph. The electronic device or apparatus of the present disclosure may be further applied to Internet, Internet of Things, data center, energy, transportation, public management, manufacturing, education, power grid, telecommunications, finance, retail, construction sites, medical, and other fields. Further, the electronic device or apparatus of the present disclosure may be further used in application scenarios including cloud, edge, and terminal related to artificial intelligence, big data, and/or cloud computing. In one or a plurality of embodiments, according to the solution of the present disclosure, an electronic device or apparatus with high computing power may be applied to a cloud device (such as the cloud server), while an electronic device or apparatus with low power consumption may be applied to a terminal device and/or an edge device (such as a smart phone or the webcam). In one or a plurality of embodiments, hardware information of the cloud device is compatible with that of the terminal device and/or the edge device. As such, according to the hardware information of the terminal device and/or the edge device, appropriate hardware resources may be matched from hardware resources of the cloud device to simulate hardware resources of the terminal device and/or the edge device to complete unified management, scheduling, and collaborative work of terminal-cloud integration or cloud-edge-terminal integration.

It is required to be explained that, for the sake of brevity, the present disclosure describes some method embodiments as a series of actions and combinations thereof, but those skilled in the art may understand that the solution of the present disclosure is not limited by an order of actions described. Therefore, according to the present disclosure or under the teaching of the present disclosure, those skilled in the art may understand that some steps of the method embodiments may be performed in a different order or simultaneously. Further, those skilled in the art may understand that the embodiments described in the present disclosure may be regarded as optional embodiments; in other words, actions and units involved thereof are not necessarily required for the implementation of a certain solution or some solutions of the present disclosure. Additionally, according to different solutions, descriptions of some embodiments of the present disclosure have their own emphases. In view of this, those skilled in the art may understand that, for a part that is not described in detail in a certain embodiment of the present disclosure, reference may be made to related descriptions in other embodiments.

In terms of specific implementations, according to the present disclosure and under the teaching of the present disclosure, those skilled in the art may understand that several embodiments disclosed in the present disclosure may be implemented in other ways that are not disclosed in the present disclosure. For example, for units in the aforementioned electronic device or apparatus embodiment, the present disclosure divides the units on the basis of considering logical functions, but there may be other division methods during actual implementations. For another example, a plurality of units or components may be combined or integrated into another system, or some features or functions in the units or components may be selectively disabled. With respect to a connection between different units or components, the connection discussed above in combination with drawings may be direct or indirect coupling between the units or components. In some scenarios, the direct or indirect coupling involves a communication connection using an interface. The communication interface may support electrical, optical, acoustic, magnetic, or other forms of signal transmission.

In the present disclosure, units described as separate components may be or may not be physically separated. Components shown as units may be or may not be physical units. The components or units may be located in a same position or distributed to a plurality of network units. Additionally, according to actual requirements, some or all of the units may be selected for achieving the purpose of the solution described in the embodiments of the present disclosure. Additionally, in some scenarios, the plurality of units in the embodiments of the present disclosure may be integrated into one unit, or each of the units may be physically separated.

In some other implementation scenarios, the integrated unit may be implemented in the form of hardware. The hardware may be a specific hardware circuit, which may include a digital circuit and/or an analog circuit, and the like. A physical implementation of a hardware structure of the circuit includes but is not limited to a physical component. The physical component includes but is not limited to a transistor, or a memristor, and the like. In view of this, various apparatuses (such as the computing apparatus or other processing apparatus) described in the present disclosure may be implemented by an appropriate hardware processor, such as a central processing unit (CPU), a graphics processing unit (GPU), a field-programmable gate array (FPGA), a digital signal processor (DSP), and an application-specific integrated circuit (ASIC), and the like. Further, the storage unit or the storage apparatus may be any appropriate storage medium (including a magnetic storage medium or a magneto-optical storage medium), such as a resistive random access memory (RRAM), a dynamic random access memory (DRAM), a static random access memory (SRAM), an enhanced dynamic random access memory (EDRAM), a high bandwidth memory (HBM), a hybrid memory cube (HMC), a read only memory (ROM), and a random access memory (RAM), and the like. The embodiments of the present disclosure have been described in detail above. The present disclosure explains principles and implementations of the present disclosure with specific examples. Descriptions of the embodiments above are only used to facilitate understanding of the method and core ideas of the present disclosure. Simultaneously, those skilled in the art may change the specific implementations and application scope of the present disclosure based on the ideas of the present disclosure. In summary, the content of this specification should not be construed as a limitation on the present disclosure.

What is claimed is:

1. A compiling method for a computing graph, implemented by a processing apparatus, the compiling method comprising:
acquiring a computing graph of a neural network model, wherein input data of the computing graph is configured with one or a plurality of groups of variable input ranges;
for each group of variable input range, compiling and optimizing the computing graph to generate a corresponding performance optimization graph; and
storing each group of variable input range in association with a corresponding performance optimization graph to generate a runtime file to be assigned to a computing apparatus to perform a task corresponding to the computing graph.

2. The compiling method of claim 1, further comprising:
adjusting the one or the plurality of variable input ranges based on hardware information of the computing apparatus that is to perform the computing graph; and
compiling and optimizing the computing graph to generate the corresponding performance optimization graph based on each group of adjusted variable input range.

3. The compiling method of claim 2, wherein the adjusting of the one of the plurality of variable input ranges comprises:
based on hardware optimization characteristics of the computing apparatus, splitting the one or the plurality of groups of variable input ranges into a plurality of groups of variable input ranges suitable for the hardware optimization characteristics.

4. The compiling method of claim 1, wherein the one or the plurality of groups of variable input ranges are configured by:
setting two mandatory fields for each input, which are min and max, to represent a variable input range of the input, wherein the min represents a minimum value of the variable input range, and the max represents a maximum value of the variable input range.

5. The compiling method of claim 4, wherein the one or the plurality of groups of variable input ranges are further configured as follows:
the min and max fields comprise the setting of a corresponding group count to form a variable input range of the corresponding group count.

6. The compiling method of claim 4, wherein the one or the plurality of groups of variable input ranges are further configured by:
setting an optional field for each input, which is opt, wherein the opt represents a preferred value in the variable input range that is set.

7. The compiling method of claim 6, wherein the one or the plurality of groups of variable input ranges are further configured by:
for each group of variable input range, setting one or a plurality of groups of preferred values for the opt field through a two-dimensional array, wherein
in the same group of variable input range, a group count of a preferred value of an opt set by each input is the same.

8. The compiling method of claim 1, wherein, for each group of variable input range, compiling and optimizing the computing graph comprises:
deriving an output shape range of each node in the computing graph according to the variable input range to perform optimization based on the derived output shape range.

9. The compiling method of claim 8, wherein the deriving of the output shape range of each node in the computing graph comprises:
acquiring a shape range of an input of the computing graph, and storing the shape range to a shape pool;
cyclically traversing each computing node in the computing graph, and performing shape range derivation; and
storing the shape range of the computing node obtained by deriving to the shape pool for shape range derivation of a next node.

10. The compiling method of claim 9, wherein the cyclically traversing and the performing of the shape range derivation comprises:
taking an input shape range corresponding to a current computing node from the shape pool;
deriving an upper limit of an output shape range of the current computing node according to an upper limit of the input shape range.
deriving a lower limit of the output shape range of the current computing node according to a lower limit of the input shape range.

11. The compiling method of claim 10, wherein the cyclically traversing and the performing of the shape range derivation further comprise:
judging whether the current computing node is able to perform true value range derivation before performing the shape range derivation on the current computing node;
performing the true value range derivation of the current computing node in response to determining that the current computing node is able to perform the true value range derivation; and
storing a true value range obtained from the true value range derivation to a true value pool.

12. The compiling method of claim 11, wherein the cyclically traversing and the performing of the shape range derivation further comprise:
performing the shape range derivation on the current computing node in response to determining that the current computing node is unable to perform the true value range derivation; in the shape range derivation, updating the upper and lower limits of the input shape range used for the derivation based on information in the true value pool; and deriving the upper and lower limits of the output shape range of the current computing node based on the updated upper and lower limits.

13. A running method for a computing graph, implemented by a computing apparatus, the running method comprising:
loading a runtime file of a computing graph, wherein the runtime file has a plurality of groups of variable input ranges and corresponding performance optimization graphs that are stored in association with the plurality of groups of variable input ranges;
according to an input value at runtime, selecting a performance optimization graph corresponding to a group of variable input range hit by the input value; and
running the selected performance optimization graph;
wherein the runtime file is generated according to a compiling method of:
acquiring a computing graph of a neural network model, wherein input data of the computing graph is configured with one or a plurality of groups of variable input ranges;
for each group of variable input range, compiling and optimizing the computing graph to generate a corresponding performance optimization graph; and
storing each group of variable input range in association with a corresponding performance optimization graph to generate the runtime file to be assigned to a computing apparatus to perform a task corresponding to the computing graph.

14. The running method of claim 13, wherein the group of variable input range hit by the input value comprises followings:
the input value falls into the variable input range; or
the input value equals the variable input range.

15. A computing apparatus, configured to run a computing graph, comprising:
a processor, configured to perform a program instruction; and
a memory, configured to store the program instruction, wherein when the program instruction is loaded and performed by the processor, the processor performs a running method of:
loading a runtime file of a computing graph, wherein the runtime file has a plurality of groups of variable input ranges and corresponding performance optimization graphs that are stored in association with the plurality of groups of variable input ranges;
according to an input value at runtime, selecting a performance optimization graph corresponding to a group of variable input range hit by the input value; and
running the selected performance optimization graph;
wherein the runtime file is generated according to a compiling method of:
acquiring a computing graph of a neural network model, wherein input data of the computing graph is configured with one or a plurality of groups of variable input ranges;
for each group of variable input range, compiling and optimizing the computing graph to generate a corresponding performance optimization graph; and
storing each group of variable input range in association with a corresponding performance optimization graph to generate the runtime file to be assigned to a computing apparatus to perform a task corresponding to the computing graph.
